(19) United States
(12) Patent Application Publication
(10) Pub. No.: US 2019/0178767 A1
(43) Pub. Date: Jun. 13, 2019

(54) Method To Carry Out Accurate Finite Element Analysis Over A Tangled Mesh

(71) Applicant: Wisconsin Alumni Research Foundation, Madison, WI (US)

(72) Inventors: Krishnan Suresh, Madison, WI (US); Joshua Danczyk, Stevens Point, WI (US)

(21) Appl. No.: 16/266,482

(22) Filed: Feb. 4, 2019

Related U.S. Application Data
(63) Continuation of application No. 13/828,673, filed on Mar. 14, 2013, now abandoned.

(51) Int. Cl. G01N 3/40; G06F 17/50

(52) U.S. Cl. CPC G01N 3/40; G06F 17/5018

(57) ABSTRACT

A method is provided for carrying out finite element analysis. The method includes the step of meshing a domain under a field with a plurality of finite elements. Each overlapping finite element is detected and a stiffness contribution due to the plurality of finite elements is calculated. A stiffness contribution due to the overlapping finite elements is also calculated and combined with the stiffness contribution due to the plurality of finite element.

### CROSS-REFERENCE TO RELATED APPLICATION

This application is a continuation of U.S. application Ser. No. 13/828,673, filed Mar. 14, 2013.

### FIELD OF THE INVENTION

This invention relates generally to finite element analysis, and in particular, to provide a method for carrying accurate finite element analysis over a tangled mesh.

### BACKGROUND AND SUMMARY OF THE INVENTION

The finite element analysis (FEA) is a numerical analysis technique that allows a user to solve complex problems by breaking it down into a finite number of simple problems. FEA is often used by engineers and designers in new product design and in the refinement of existing products. Using FEA, a user is able to verify a proposed design of a product will perform in accordance with desired specifications prior to manufacturing or construction of such product.

In FEA, the geometry of the proposed design is identified. The geometry is broken up into a discrete representation, known as a mesh or grid. The mesh is made up of a plurality of finite elements defined by simple polynomial shape functions, wherein the vertices of the shape define nodes. Boundary conditions (e.g. stress, constraints and/or loads) are applied to the mesh and the displacement of the elements is determined by the nodal displacements. Once the nodal displacements are known, element stresses and strains can be calculated. The governing equations are assembled into matrix form and are solved numerically.

In classic FEA, the underlying mesh is required to satisfy certain topological and geometrical properties. One such critical property is that none of the elements must overlap, i.e., the mesh must not be tangled. Because tangled meshes generate physically invalid solutions, it is imperative that the meshes be untangled prior to solving the governing equations. However, as hereinafter described, the tangling of a finite element mesh is unavoidable in modern FEA.

The tangling of finite element meshes can occur during various operations. For example, in an effort to generate all-hex meshes, mesh generators can inadvertently introduce tangling. Similarly, mesh optimizers can introduce tangling. Further, in large-scale deformation excessive node movement relative to the local size of the finite elements can result in tangling. Finally, tangling can occur when an existing mesh is morphed to reflect a design change. The untangling of a mesh is perhaps as difficult as mesh generation and optimization, and has received considerable attention from the finite element community. As such, it would be highly desirable to provide an alternative to ‘untangling’ of a finite element mesh which would allow a user to generate physically valid solutions to the equations governing a proposed design.

Therefore, it is a primary object and feature of the present invention to provide a method for carrying accurate finite element analysis over a tangled mesh.

It is a further object and feature of the present invention to provide a method for carrying out accurate finite element analysis over a tangled mesh which is simple and inexpensive to implement.

It is a still further object and feature of the present invention to provide a method for carrying out accurate finite element analysis over a tangled mesh which allows a user to generate physically valid solutions to the equations governing a proposed design.

In accordance with the present invention, a method is provided for carrying accurate finite element analysis. The method includes the step of meshing a domain subjected to a field. The mesh is defined by a plurality of finite elements. A stiffness contribution due to the plurality of finite elements is computed and a stiffness contribution due to the finite elements overlapping corresponding finite elements is computed. The stiffness contribution due to the plurality of finite elements and the stiffness contribution due to the overlapping finite elements are combined.

Each of the finite elements is defined by a plurality of nodes and each finite element has an orientation. In addition, each node has a nodal shape function. The nodal shape functions are defined according to the expression:

$${φ}_{i} ( • ) = {\sum }_{j ∈ C ( i )} {Θ}_{j} {N}_{i , j} ( • )$$

wherein ϕᵢ(⋅) are the nodal shape functions; j is a finite element; i is a node; C [symbol] i [symbol] is a set of finite elements connected to node i; Θⱼ is the orientation of the finite element j; and N_{i,j}(⋅) are element shape functions.

The stiffness contribution due to the plurality of finite elements may be calculated according to the expression:

$${K}_{standard} = {\sum }_{j} {\int }_{{E}_{j}} ( ∇ {N}_{i} ) \cdot ( ∇ {N}_{j} ) d Ω$$

wherein: K_{standard} is a stiffness matrix due to the plurality of finite elements; j is a finite element; Eⱼ is a region covered by each of the finite elements; ∇Nᵢ is a spatial gradient of a function Nᵢ; ∇Nⱼ is a spatial gradient of a function Nⱼ; and dΩ is a boundary of a region covered by each finite element.

The stiffness contribution due to the overlapping finite elements may calculated according to the expression:

$${K}_{overlapping} = {\sum }_{j} {\sum }_{k \neq j} {\int }_{{E}_{j} ⋂ {E}_{k}} {Θ}_{j} {Θ}_{k} ∇ {N}_{j} \cdot ∇ {N}_{k} d Ω$$

wherein: K_{overlapping} is a stiffness matrix of the overlapping elements; j is a finite element; k is a finite element overlapping finite element j; Eⱼ ∩ Eₖ is an overlapping region between finite elements, j and k; Θⱼ is the orientation of the first finite element j; Θₖ is the orientation of the second finite element k; ∇Nⱼ is a spatial gradient of a function Nⱼ; ∇Nₖ is a spatial gradient of a function Nₖ; and dΩ is the boundary of a region covered by the elements, j and k.

The step of combining the stiffness of the finite elements and the stiffness of the overlapping finite elements may include the additional step of summing the stiffness of the plurality of finite elements and the stiffness of the overlapping finite elements.

In accordance with a further aspect of the present invention, a method is provided for carrying out finite element analysis. The method includes the steps of meshing a domain under a field with a plurality of finite elements and detecting if each finite element overlaps a finite element. A stiffness contribution due to the plurality of finite elements is calculated and a stiffness contribution due to the overlapping finite elements are calculated. The stiffness contribution due to the plurality of finite elements and the stiffness contribution due to the tangled finite elements are combined.

Each of the finite elements is defined by a plurality of nodes and each finite element has an orientation. Each node has a nodal shape function and the nodal shape functions are defined according to the expression:

$${φ}_{i} ( • ) = {\sum }_{j ∈ C ( i )} {Θ}_{j} {N}_{i , j} ( • )$$

wherein ϕᵢ(⋅) are the nodal shape functions; j is a finite element; i is a node; C♭i? is a set of finite elements connected to node i; Θⱼ is the orientation of finite element j; and N_{i,j}(⋅) are element shape functions.

The stiffness contribution due to the plurality of finite elements may be calculated according to the expression:

$${K}_{standard} = {\sum }_{j} {\int }_{{E}_{j}} ( {▽N}_{i} ) \cdot ( {▽N}_{j} ) d Ω$$

wherein: K_{standard} is a stiffness matrix of the plurality of finite elements; j is a finite element; Eⱼ is a region covered by each of the finite elements; ∇Nᵢ is a spatial gradient of a function Nᵢ; ∇Nⱼ is a spatial gradient of a function Nⱼ; and dΩ is a boundary of a region covered by each finite element.

The stiffness contribution of the overlapping finite elements may be calculated according to the expression:

$${K}_{overlapping} = {\sum }_{j} {\sum }_{k \neq j} {\int }_{{E}_{j} ⋂ {E}_{k}} {Θ}_{j} {Θ}_{k} {▽ N}_{j} \cdot {▽ N}_{k} d Ω$$

wherein: K_{overlapping} is a stiffness matrix of the overlapping elements; j is a finite element; k is a finite element overlapping finite element j; Eⱼ ∩ Eₖ is an overlapping region between first and second finite elements, j and k; Θⱼ is the orientation of the first finite element j; Θₖ is the orientation of the second finite element k; ∇Nⱼ is a spatial gradient of a function Nⱼ; ∇Nₖ is a spatial gradient of a function Nₖ; and dΩ is the boundary of a region covered by the elements, j and k.

The step of combining the stiffness of the plurality of finite elements and the stiffness of the tangled finite elements includes the step of summing the stiffness of the plurality of finite elements and the stiffness of the tangled finite elements. In addition, the step of detecting if each finite element is tangled includes the step of determining if a finite element overlaps an adjacent finite element and if the finite element overlaps the adjacent finite element, determining that the finite element is tangled.

In accordance with a still further aspect of the present invention, a method is provided for carrying out finite element analysis. The method includes the steps of meshing a domain under a field with a plurality of finite elements and determining a stiffness contribution due to the plurality of finite elements. A stiffness contribution due to a subset of the plurality of finite elements is determined and combined with the stiffness contribution due to the plurality of finite elements.

It is contemplated for the finite element to be triangle. Each triangle is defined by a first point, a second point and a third point in order. The first and second points define a first segment, the second and third points define a second segment and the third and first points define a third segment. The first, second and third segments define an interior of the triangle. Alternatively, each finite element may be a tetrahedron. Each tetrahedron is defined by a first point, a second point, a third point and a fourth point in order. The first, second and third points define a first plane; the second, third, and fourth points define a second plane; the third, fourth, and first points define a third plane; and the fourth, first and second points define a fourth plane. The first, second, third and fourth planes define an interior of the tetrahedron. The orientation of each finite element is determined by computing a determinant of the Jacobian.

Each of the finite elements is defined by a plurality of nodes and each finite element has an orientation. In addition, each node has a nodal shape function. The nodal shape functions are defined according to the expression:

$${φ}_{i} ( • ) = {\sum }_{j ∈ C ( i )} {Θ}_{j} {N}_{i , j} ( • )$$

wherein ϕᵢ(⋅) are the nodal shape functions; j is a finite element; i is a node; C♭i? is a set of finite elements connected to node i; Θⱼ is the orientation of the finite element j; and N_{i,j}(⋅) are element shape functions.

The stiffness contribution due to the plurality of finite elements may be calculated according to the expression:

$${K}_{standard} = {\sum }_{j} {\int }_{{E}_{j}} ( {▽N}_{i} ) \cdot ( {▽N}_{j} ) d Ω$$

wherein: K_{standard} is a stiffness matrix of the plurality of finite elements; j is a finite element; Eⱼ is a region covered by each of the finite elements; ∇Nⱼ is a spatial gradient of a function Nᵢ; ∇Nⱼ is a spatial gradient of a function Nⱼ; and dΩ is a boundary of a region covered by each finite element.

The stiffness contribution due to the subset of finite elements may calculated according to the expression:

$${K}_{overlapping} = {\sum }_{j} {\sum }_{k \neq j} {\int }_{{E}_{j} ⋂ {E}_{k}} {Θ}_{j} {Θ}_{k} {▽ N}_{j} \cdot {▽ N}_{k} d Ω$$

wherein: K_{overlapping} is a stiffness matrix due to the subset of finite elements; j is a finite element; k is a finite element overlapping finite element j; Eⱼ ∩ Eₖ is an overlapping region between finite elements, j and k; Θⱼ is the orientation of the finite element j; Θₖ is the orientation of the finite element k; ∇Nⱼ is a spatial gradient of a function Nⱼ; ∇Nₖ is a spatial gradient of a function Nₖ; and dΩ is the boundary of a region covered by the elements, j and k.

The step of combining the stiffness of the finite elements and the stiffness of the subset of finite elements may include the additional step of summing the stiffness of the plurality of finite elements and the stiffness of the subset of finite elements.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiment.

In the drawings:

FIG. 1 is a schematic view of an untangled finite element mesh;

FIG. 2 is a schematic view of a tetrahedral finite element;

FIG. 3 is a schematic view of a tangled finite element mesh; and

FIG. 4 is a schematic view of an invalid, tangled finite element mesh.

### DETAILED DESCRIPTION OF THE DRAWINGS

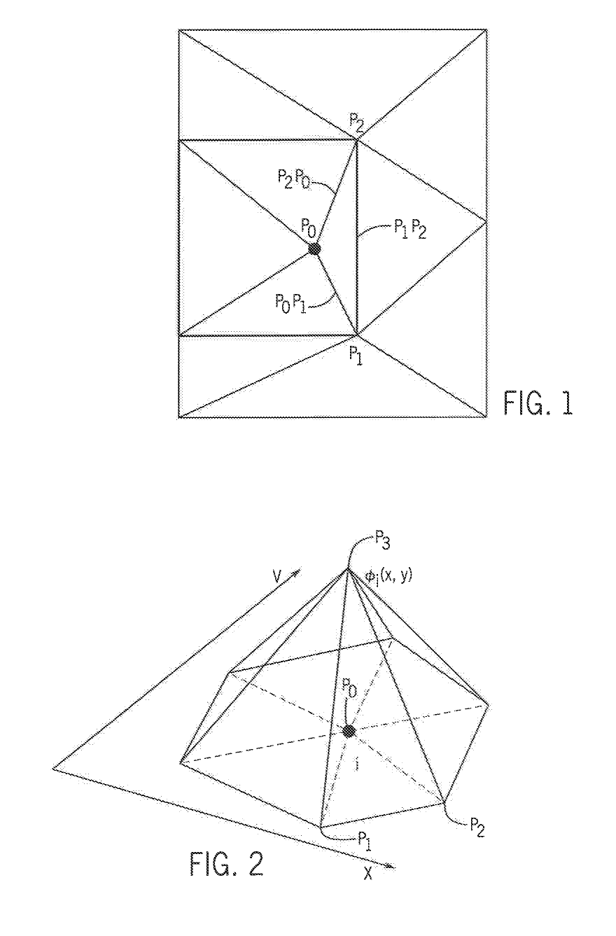

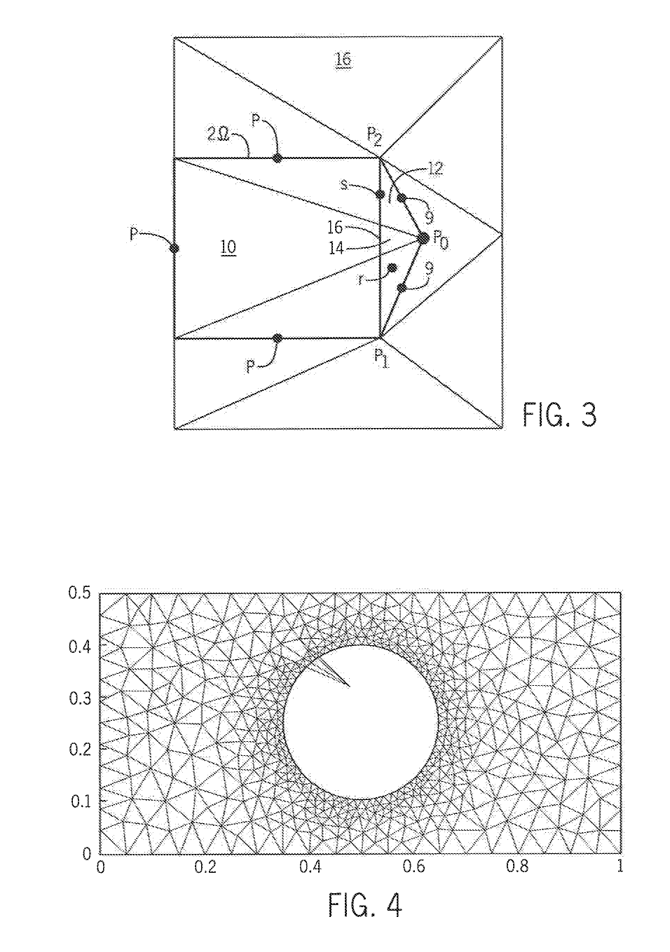

In classic FEA, one attempts to verify that a proposed design of a product will perform in accordance with desired specifications by approximating a solution to an underlying field equation, such as the Poisson equation:

$$\begin{matrix}∇ \cdot ∇ u \cdot = - f in Ω & Equation ( 1 ) \\ u {\vert}_{\partial Ω} = 0 & \end{matrix}$$

wherein: u is the unknown field, such as temperature; ƒ is a body heat; Ω is a region; and ∂Ω is a boundary of the region of the product. Other field problems such as structural or magnetic may be posed in a similar form. The first step towards solving Equation (1) is to create a finite element mesh over the domain Ω. For simplicity, only simplicial meshes, i.e., 2-D triangular, FIGS. 1, and 3-D tetrahedral elements are considered hereafter. However, other types of meshes may be utilized without deviating from the scope of the present invention. Heretofore, in classic FEA, the mesh needed to satisfy certain topological and geometrical properties. For example, in 2-D triangular meshes, the following conditions must be satisfied:

1. Every element must be defined by exactly three nodes.

2. Every element must be positively oriented, i.e., the determinant of the Jacobian must be positive.

3. No two elements must overlap.

4. Every node must be connected to at least one element.

Meshes which satisfy the above-noted condition are referred to as being valid.

In FEA, approximate functions are constructed by seeking solutions of the form:

$$u ( • ) = {\sum }_{i} {\hat{u}}_{i} {φ}_{i} ( • ) \qquad Equation ( 2 )$$

wherein: ûᵢ is the degree of freedom associated with node i, and ϕᵢ(⋅) are nodal shape functions or “hat functions” that take a value of 1 at that node, and go to zero beyond the set of elements connected to node i, FIG. 2. It is noted that in Equation (2), ϕᵢ(⋅) is an abbreviated notation for ϕᵢ(x, y) in 2D, and ϕᵢ(x, y, z) in 3D.

In addition, the hat function is usually decomposed into disjoint element shape functions N_{i,j}(⋅) defined over each element j connected to node i. Unfortunately, as hereinafter described, when a mesh is tangled or in other words when the above conditions are not satisfied, the above process leads to erroneous results.

For a 2-D simplicial element, FIG. 1, such as a triangle, the phrase ‘orientation of an element’ may be defined by three points, P₀, P₁, and P₂ (in that order) such that if the interior of the element lies to the left of the oriented segment P₀P₁, (or equivalently P₁P₂ or P₂P₀), the triangle is positively oriented. Otherwise, the triangle is negatively oriented. For a 3-D simplicial element, FIG. 2, such as a tetrahedron, the phrase ‘orientation of an element’ may be defined by four points, P₀, P₁, P₂ or P₃ (in that order) such that if the interior of the element lies to the left of the oriented plane P₀P₁P₂ (or equivalently P₁P₂P₃, P₂P₃P₀or P₃P₀P₁), the tetrahedron is positively oriented. Otherwise, the tetrahedron is negatively oriented. It can be appreciated that the above definitions of ‘orientation of an element’ for simplicial elements is equivalent to other definitions of the ‘orientation of an element’ involving the determinant of the Jacobian. It can be understood that in a valid mesh, as heretofore described, all elements are positively oriented.

On the other hand, a mesh is tangled if: (a) one or more elements have a negative orientation; and (b) the mesh can be untangled, i.e., the mesh may be converted into a valid mesh with all positively oriented elements through some hypothetical movement of nodes. It is noted that the definition of a tangled mesh only requires the existence of node movement. This, in turn, eliminates meshes that are topologically corrupt. Further, it is assumed that the tangling of the mesh is internal, i.e., that the overall geometry defined by the tangled mesh is exactly the same as the original geometry Ω defined via the valid mesh. Thus, the mesh shown in FIG. 4 wherein a node goes beyond the boundary of the original geometry is not considered here.

Referring to FIG. 3, in a tangled mesh, it is noted there must exist a pair of neighboring elements 10 and 12 with opposite orientation, and such pairs must overlap, i.e., there are points 14 within Ω that belong to both elements. The boundary 16 shared by two oppositely oriented elements is of significant importance. More specifically, the common boundary of neighboring and oppositely oriented elements is referred to as a fold. Since only simplicial elements are being considered, the fold must necessarily occur at the common boundary.

If a classic FEA approximation, as in Equation (2), is sought over a tangled mesh, the nodal shape function ϕᵢ(⋅) can no longer be decomposed into disjoint element shape functions due to the guaranteed presence of overlapping elements. As a result, the required continuity of the functional space is lost. While it is possible to ignore this violation and carry out a finite element assembly, followed by a solution to obtain the nodal values over the tangled mesh, erroneous results appear later in numerical results.

In order to handle tangled meshes, the methodology of the present invention contemplates a modification to classic FEA. More specifically, for any node i in a tangled mesh, C(i) may be defined as the set of elements connected to it. As such, the nodal shape functions maybe defined as:

$${φ}_{i} ( • ) = {\sum }_{j ∈ C ( i )} {Θ}_{j} {N}_{i , j} ( • ) \qquad Equation ( 3 )$$

wherein ϕᵢ(⋅) are the nodal shape functions; j is a finite element; i is a node; C♭i? is a set of finite elements connected to node i; Θⱼ is the orientation of the finite element j; and N_{i,j}(⋅) are element shape functions.

It is noted that if all elements connected to node i are positively or negatively oriented, then Equation (3) is the classic hat function, heretofore described. In the event that a portion of the elements in C♭i? are negatively oriented, while others are positively oriented, it can be proven that:

1. ϕᵢ(⋅)=0 over ∂Ωᵢ; and

2. ϕᵢ(⋅) is continuous in Ωᵢ.

First, consider the statement: ϕᵢ(⋅)=0 over ∂Ωᵢ. Since only simplicial elements are being considered, as heretofore described, points on ∂Ωᵢmust also lie on the boundary of one or more elements in C♭i?. If a point lies on the boundary of a single element (example: point p in FIG. 3), then, by definition, the element shape function of that element goes to zero at that point. Further, per Equation (3), the nodal shape function ϕᵢ(⋅) depends only on that element at that point, and therefore, also goes to zero at that point. Now, suppose a point on ∂Ωᵢ lies on the boundary of more than one element in C(i) (example: point q in FIG. 3), then the point must lie on a fold. Since the element shape functions are defined to be continuous across element boundaries, and since the two elements have opposite orientations, then, per Equation (3), their net contribution is zero, i.e., ϕᵢ(⋅) goes to zero at point q.

Now consider the statement: ϕᵢ(⋅) is continuous in Ωᵢ. Here again, there are only two cases to consider. First, referring to FIG. 3, consider the continuity at a point r that lies in the interior of one or more elements. Since the element shape functions N_{i,j}(⋅) are defined to be continuous in the interior of elements and since ϕᵢ(⋅) is linear combination of such functions, the continuity of the latter is guaranteed. Second, consider the continuity at a point s that lies in the interior of Ωᵢ, but on the boundary of the elements. The element shape functions N_{i,j}(⋅) at the boundary of neighboring elements are guaranteed to continuous, once again by construction. Therefore, since ϕᵢ(⋅) is a linear sum of such functions, it is also continuous. Finally, by generalization, any point that falls into both of the above categories, i.e., lies in the interior of certain elements and lies on the boundary of other elements, is also continuous.

In order to implement the methodology of the present invention, it is contemplated not to use the nodal shape functions ϕᵢ(⋅) directly. Instead, element shape functions N_{i,j}(⋅) may be used for reasons of computational ease and efficiency. More specifically, the field (e.g. stress, thermal or magnetic fields) over a mesh may be expressed at any point as the sum over all elements that contain that point:

$$u ( • ) = {\sum }_{j} {u}_{j} ( • ) \qquad Equation ( 4 )$$

wherein: u(⋅) is the field (e.g. stress, thermal or magnetic fields) over a mesh; and uⱼ(⋅) the field over an element j.

The field over an element j (uⱼ(⋅)) is simply the oriented sum of contributions from all nodes i that define that element and may be calculated according to the expression:

$${u}_{j} ( • ) = {\sum }_{k \vert p ∈ {E}_{j}} {Θ}_{j} {\sum }_{i \vert j ∈ C [ i ]} {\hat{u}}_{i} {N}_{i , j} ( • ) \qquad Equation ( 5 )$$

wherein: uⱼ(⋅) the field over an element j; Θⱼ is the orientation of the finite element j; Eⱼ is the region of element j; i is a node; C♭i? is a set of finite elements connected to node i; ûᵢ is the degree of freedom associated with node i; and N_{i,j}(⋅) are element shape functions.

The stiffness contribution due to each element, whether positively or negatively orientated, is calculated and assembled according to the standard expression:

$${K}_{standard} = {\sum }_{j} {\int }_{{E}_{j}} ( {▽N}_{j} ) \cdot ( {▽N}_{j} ) d Ω \qquad Equation ( 6 )$$

wherein: K_{standard} is the stiffness matrix of the entire set of elements; j is a finite element; Eⱼ is a region covered by each element; ∇Nⱼ is the spatial gradient of the function Nᵢ; ∇Nⱼ is the spatial gradient of the function Nⱼ; and dΩ is an infinitesimal region.

The stiffness contribution due to each pair of overlapping elements is calculated and assembled according to the expression:

$${K}_{overlapping} = {\sum }_{j} {\sum }_{k \neq j} {\int }_{{E}_{j} ⋂ {E}_{k}} {Θ}_{j} {Θ}_{k} ∇ {N}_{j} \cdot ∇ {N}_{k} d Ω \qquad Equation ( 7 )$$

wherein: K_{overlapping} is the stiffness matrix due to each pair of overlapping elements; j is a finite element; k is a finite element overlapping finite element j; Eⱼ ∩ Eₖ is an overlapping region between the elements, j and k; Θⱼ is the orientation of the finite element j; Θₖ is the orientation of the finite element k; ∇Nⱼ is the spatial gradient of the function Nⱼ; ∇Nₖ is the spatial gradient of the function Nₖ; and dΩ is an infinitesimal region. It may be appreciated that in an untangled mesh, no two elements overlap, and therefore, the K_{overlapping} matrix is zero.

The combined stiffness matrix is calculated according to the expression:

K=K_{standard}+K_{overlapping} Equation (8)

wherein: K is the combined stiffness; K_{standard} is the stiffness of each element; and K_{overlapping} is the stiffness due to each pair of overlapping elements.

The external force over a tangled mesh is computed according to the expression:

$${f}_{oriented} = {\sum }_{j} {\int }_{{E}_{j}} {Θ}_{j} {N}_{j} fd Ω \qquad Equation ( 9 )$$

wherein: ƒ_{oriented} is the external force over a tangled mesh; j is a finite element; Eⱼ is a region covered by each element; Θⱼ is the orientation of the finite element j; ƒ is the body force; and dΩ is an infinitesimal region. It can be appreciated that if the orientation is all positive, then Equation (9) results in the standard body force.

It can be appreciated that the terms of above equations may be rewritten in the matrix form as follows:

Kû=ƒ_{oriented} Equation (10)

wherein: K is the combined stiffness, as heretofore described; û is the collection of all nodal degrees of freedom; and ƒ_{oriented} is external force over a tangled mesh.

The methodology, as heretofore described, is an extension to the underlying mathematics of the classic finite element formulation. The methodology of the present invention allows for FEA to be used in conjunction with tangled meshes that were previously considered unacceptable. In addition, the methodology can be easily incorporated into classic FEA with minor modifications.

Various modes of carrying out the invention are contemplated as being within the scope of the following claims particularly pointing out and distinctly claiming the subject matter, which is regarded as the invention.

We claim:

1. A method for finite element analysis of a product geometry comprising the steps of:
defining a domain of the product geometry;
meshing the domain of the product geometry, the mesh being defined by a plurality of finite elements;
determining that the mesh is a tangled mesh including a plurality of non-overlapping finite elements and at least two overlapping finite elements;
computing a stiffness contribution due to the plurality of non-overlapping finite elements for the tangled mesh;
computing an overlapping stiffness contribution due to the at least two overlapping finite elements for the tangled mesh;
combining the stiffness contribution and the overlapping stiffness contribution;
applying user selected boundary conditions to the mesh;
calculating an effect of the boundary conditions on the plurality of finite elements; and
verifying the product geometry will perform in accordance with the desired specifications in response to the effect.

2. The method of claim 1 wherein each of the finite elements is defined by a plurality of nodes.

3. The method of claim 2 wherein each finite element has an orientation and wherein each node has a nodal shape function, the nodal shape functions being defined according to the expression:
$${φ}_{i} ( • ) = {\sum }_{j ∈ C ( i )} {Θ}_{j} {N}_{i , j} ( • )$$
wherein ϕᵢ(⋅) are the nodal shape functions; j is a finite element; i is a node; C♭i? is a set of finite elements connected to node i; Θⱼ is the orientation of the finite element j; and N_{i,j}(⋅) are element shape functions.

4. The method of claim 1 wherein the stiffness contribution due to the plurality of non-overlapping finite elements is calculated according to the expression:
$${K}_{standard} = {\sum }_{j} {\int }_{{E}_{j}} ( ∇ {N}_{i} ) \cdot ( ∇ {N}_{j} ) d Ω$$
wherein: K_{standard} is a stiffness matrix of the plurality of finite elements; j are the finite elements; Eⱼ is a region covered by each of the non-overlapping finite elements; ∇Nᵢ is a spatial gradient of a function Nᵢ; ∇Nⱼ is a spatial gradient of a function Nⱼ; and dΩ is an infinitesimal region.

5. The method of claim 1 wherein each finite element has an orientation and wherein the stiffness contribution due to the overlapping finite elements is calculated according to the expression:
$${K}_{overlapping} = {\sum }_{j} {\sum }_{k \neq j} {\int }_{{E}_{j} ⋂ {E}_{k}} {Θ}_{j} {Θ}_{k} ∇ {N}_{j} \cdot ∇ {N}_{k} d Ω$$
wherein: K_{overlapping} is a stiffness matrix of the overlapping finite elements; j is a finite element; k is a second finite element overlapping finite element j; Eⱼ ∩ Eₖ is an overlapping region between finite elements, j and k; Θⱼ is the orientation of finite element j; Θₖ is the orientation of finite element k; ∇Nⱼ is a spatial gradient of a function Nⱼ; ∇Nₖ is a spatial gradient of a function Nₖ; and dΩ is an infinitesimal region.

6. The method of claim 1 wherein the step of combining the standard stiffness of the plurality of finite elements and the overlapping stiffness of the overlapping finite elements includes the step of summing the stiffness of the plurality of non-overlapping finite elements and the stiffness of the overlapping finite elements.

7. A computer-implemented method for finite element analysis of a proposed product design, the proposed product design having desired specifications, by executing computing steps defined in a computer program stored in non-transient memory of a finite element analysis computer, comprising the steps of:
meshing a domain of the proposed product design with a plurality of finite elements;
detecting if at least one finite element overlaps at least one other finite element such that the mesh is a tangled mesh;
calculating a standard stiffness contribution due to the plurality of finite elements;
calculating an overlapping stiffness contribution due to the overlapping finite elements;
combining the standard stiffness contribution and the overlapping stiffness contribution;
applying user selected boundary conditions to the mesh;
calculating an effect of the boundary conditions on the plurality of finite elements; and
verifying the proposed product design will perform in accordance with the desired specifications in response to the effect.

8. The computer-implemented method of claim 7 wherein each of the finite elements is defined by a plurality of nodes.

9. The computer-implemented method of claim 8 wherein each finite element has an orientation and wherein each node has a nodal shape function, the nodal shape functions being defined according to the expression:
$${φ}_{i} ( • ) = {\sum }_{j ∈ C ( i )} {Θ}_{j} {N}_{i , j} ( • )$$
wherein ϕᵢ(⋅) are the nodal shape functions; j is a finite element; i is a node; C♭i? is a set of finite elements connected to node i; Θⱼ is the orientation of finite element j; and N_{i,j}(⋅) are element shape functions.

10. The computer-implemented method of claim 7 wherein the stiffness contribution due to the plurality of non-overlapping finite elements is calculated according to the expression:
$${K}_{standard} = {\sum }_{j} {\int }_{{E}_{j}} ( ∇ {N}_{i} ) \cdot ( ∇ {N}_{j} ) d Ω$$
wherein: K_{standard} is a stiffness matrix due to the plurality of non-overlapping finite elements; j is a finite element; Eⱼ is a region covered by each of the finite elements; ∇Nᵢ is a spatial gradient of a function Nᵢ; ∇Nⱼ is a spatial gradient of a function Nⱼ; and dΩ is an infinitesimal region.

11. The computer-implemented method of claim 7 wherein each overlapping finite element has an orientation and wherein the stiffness contribution of the overlapping elements is calculated according to the expression:
$${K}_{overlapping} = {\sum }_{j} {\sum }_{k \neq j} {\int }_{{E}_{j} ⋂ {E}_{k}} {Θ}_{j} {Θ}_{k} ∇ {N}_{j} \cdot ∇ {N}_{k} d Ω$$
wherein: K_{overlapping} is a stiffness matrix due of the overlapping elements; j is a finite element; k is a finite element overlapping first finite element j; Eⱼ ∩ Eₖ is an overlapping region between finite elements, j and k; Θⱼ is the orientation of the first finite element j; Θₖ is the orientation of the second finite element k; ∇Nⱼ is a spatial gradient of a function Nⱼ; ∇Nₖ is a spatial gradient of a function Nₖ; and dΩ is an infinitesimal region.

12. The computer-implemented method of claim 7 wherein the step of combining the standard stiffness of the non-overlapping finite elements and the overlapping stiffness of overlapping finite elements includes the step of summing the standard stiffness of the finite elements and overlapping the stiffness of the overlapping finite elements.

13. A computer-implemented method for finite element analysis of a product design, the product design having desired specifications, by executing computing steps defined in a computer program, comprising the steps of:
meshing a domain of the product design with a plurality of finite elements;
determining that the mesh is a tangled mesh including a plurality of non-overlapping finite elements and at least two overlapping finite elements;
determining a standard stiffness contribution of the plurality of finite elements;
determining an overlapping stiffness contribution of a subset of the plurality of finite elements;
combining the standard stiffness contribution of the plurality of finite elements and the overlapping stiffness contribution due to the subset of finite elements;
applying a boundary condition to the mesh;
determining an effect of the boundary condition on the plurality of finite elements; and
verifying the product design will perform in accordance with the desired specifications in response to the effect.

14. The computer-implemented method of claim 13 wherein each finite element is triangle, each triangle:
defined by a first point, a second point and a third point in order;
the first and second points define a first segment, the second and third points define a second segment and the third and first points define a third segment; and
the first, second and third segments define an interior of the triangle.

15. The computer-implemented method of claim 14 wherein the orientation of each finite element is determined by computing a determinant of the Jacobian.

16. The computer-implemented method of claim 15 wherein each finite element is tetrahedron, each tetrahedron:
defined by a first point, a second point, a third point and a fourth point in order;
the first, second and third points define a first plane; the second, third, and fourth points define a second plane; the third, fourth, and first points define a third plane; and the fourth, first and second points define a fourth plane; and
the first, second, third and fourth planes define an interior of the tetrahedron.

17. The computer-implemented method of claim 16 wherein the orientation of each finite element is determined by computing a determinant of the Jacobian.

18. The computer-implemented method of claim 13 wherein each of the finite elements is defined by a plurality of nodes.

19. The computer-implemented method of claim 18 wherein each finite element has an orientation and wherein each node has a nodal shape function, the nodal shape function being defined according to the expression:
$${φ}_{i} ( • ) = {\sum }_{j ∈ C ( i )} {Θ}_{j} {N}_{i , j} ( • )$$
wherein ϕᵢ(⋅) are the nodal shape functions; j is a finite element; i is a node; C♭i? is a set of finite elements connected to node i; Θⱼ is the orientation of the finite element j; and N_{i,j}(⋅) are element shape functions.

20. The computer-implemented method of claim 13 wherein the standard stiffness contribution due to the plurality of finite elements is calculated according to the expression:
$${K}_{standard} = {\sum }_{j} {\int }_{{E}_{j}} ( ∇ {N}_{i} ) \cdot ( ∇ {N}_{j} ) d Ω$$
wherein: K_{standard} is a stiffness matrix of the plurality of finite elements; j is a finite element; Eⱼ is a region covered by each of the finite elements; ∇Nᵢ is a spatial gradient of a function Nᵢ; ∇Nⱼ is a spatial gradient of a function Nⱼ; and dΩ is an infinitesimal region.

21. The computer-implemented method of claim 13 wherein each finite element has an orientation and wherein the overlapping stiffness contribution due to the subset of finite elements is calculated according to the expression:
$${K}_{overlapping} = {\sum }_{j} {\sum }_{k \neq j} {\int }_{{E}_{j} ⋂ {E}_{k}} {Θ}_{j} {Θ}_{k} ∇ {N}_{j} \cdot ∇ {N}_{k} d Ω$$
wherein: K_{overlapping} is a stiffness matrix of the subset elements; j is a finite element; k is a finite element overlapping finite element j; Eⱼ ∩ Eₖ is an overlapping region between finite elements, j and k; Θⱼ is the orientation of the first finite element j; Θₖ is the orientation of the second finite element k; ∇Nⱼ is a spatial gradient of a function Nⱼ; ∇Nₖ is a spatial gradient of a function Nₖ; and dΩ is an infinitesimal region.

22. The computer-implemented method of claim 13 wherein the step of combining the standard stiffness of the plurality of finite elements and the overlapping stiffness of the subset of finite elements includes the step of summing the standard stiffness of the finite elements and the overlapping stiffness of the subset finite elements.
